(19) United States
(12) Patent Application Publication
(10) Pub. No.: US 2007/0218475 A1
(43) Pub. Date: Sep. 20, 2007

(54) Efficient drug screening for protein targets

(76) Inventors: Philip A. Beachy, Stanford, CA (US); Anssi Jussi N. Taipale, Espoo (FI); James K. Chen, Mountain View, CA (US)

Correspondence Address: DLA PIPER US LLP, 4365 EXECUTIVE DRIVE, SUITE 1100, SAN DIEGO, CA, 92121-2133, US

(21) Appl. No.: 11/603,473

(22) Filed: Nov. 21, 2006

Related U.S. Application Data
(60) Provisional application No. 60/739,233, filed on Nov. 22, 2005.

(51) Int. Cl. C40B 30/06; C40B 40/08; C40B 40/10

(52) U.S. Cl. 435/6; 435/7.1

(57) ABSTRACT

The methods of the invention allow extremely high throughput screening of chemicals against a large number of pharmacologically relevant targets. All of the pharmacologically relevant targets are expressed in cells, which are then screened against a fluorescently-tagged combinatorial library. Binding of the small molecules to the cells is then detected by fluorescence activated cell sorting or imaging.

### CROSS REFERENCE TO RELATED APPLICATION(S)

This application claims the benefit of priority under 35 U.S.C. § 119(e) of U.S. Ser. No. 60/739,233, filed Nov. 22, 2005, the entire content of which is incorporated herein by reference.

### GRANT INFORMATION

This invention was made with government support under Grant No. NTH K08 awarded by the National Institutes of Health. The United States government has certain rights in this invention.

### BACKGROUND OF THE INVENTION

1. Field of the Invention

The invention relates generally to methods of screening for small molecules against pharmacologically relevant targets, and more specifically to methods of detecting specific small molecule-protein binding partners.

2. Background Information

A significant problem in pharmaceutical discovery is that there are a large number of pharmacologically relevant proteins, and a very large number of distinct drug-like small molecules to be screened. Typically, pharmaceutical discovery has proceeded by identification of a potential target, and subsequent screening of large number of small molecules against this target. Sequencing of the genomes of humans, parasites, bacteria and viruses has led to the discovery of a large number (on the order of 10,000) of potential pharmacological targets. If screening proceeds at the current rate of approximately 100 targets per year at a cost of roughly $100,000 to $1,000,000 per target for screening and assays, it will take about 100 years and $1-$10 billion to complete.

In order to develop drugs and methods for specifically treating a particular disease, such as cancer, while sparing normal tissues, an understanding of the molecular mechanisms involved in the etiology of the disease is required. For example, by identifying one or more molecular pathways that are aberrantly regulated in a cancerous cell as compared to a corresponding normal cell, and further identifying the defect leading to the aberrant regulation, drugs can be developed that target the defect and, therefore, can be relatively specific for the cancer cells having the defect.

Pattern formation is the activity by which embryonic cells form ordered spatial arrangements of differentiated tissues. Speculation on the mechanisms underlying these patterning effects usually centers on the secretion of a signaling molecule that elicits an appropriate response from the tissues being patterned. More recent work aimed at the identification of such signaling molecules implicates secreted proteins encoded by individual members of a small number of gene families.

Members of the Hedgehog family of signaling molecules mediate many important short- and long-range patterning processes during invertebrate and vertebrate development. Exemplary hedgehog genes and proteins are described in PCT publications WO 95/18856 and WO 96/17924. The vertebrate family of hedgehog genes includes at least four members, three of which, herein referred to as Desert hedgehog (Dhh), Sonic hedgehog (Shh) and Indian hedgehog (Ihh), apparently exist in all vertebrates, including fish, birds, and mammals. A fourth member, herein referred to as tiggie-winkle hedgehog (Thh), appears specific to fish. Desert hedgehog (Dhh) is expressed principally in the testes, both in mouse embryonic development and in the adult rodent and human; Indian hedgehog (Ihh) is involved in bone development during embryogenesis and in bone formation in the adult; and, Shh is primarily involved in morphogenic and neuroinductive activities. Given the critical inductive roles of hedgehog polypeptides in the development and maintenance of vertebrate organs, the identification of hedgehog interacting proteins and their role in the regulation of gene families known to be involved in cell signaling and intercellular communication provides a valuable resource of potentially relevant targets.

Plants of the genus Veratrum have a long history of use in the folk remedies of many cultures, and the jervine family of alkaloids, which constitute a majority of Veratrum secondary metabolites, have been used for the treatment of hypertension and cardiac disease. The association of Veratrum californicum with an epidemic of sheep congenital deformities during the 1950s, raised the possibility that jervine alkaloids are also potent teratogens. Extensive investigations by the United States Department of Agriculture subsequently confirmed that jervine and cyclopamine (11-deoxojervine) given during gestation can directly induce cephalic defects in lambs, including cyclopia in the most severe cases.

It is now known that the teratogenic effects of jervine and cyclopamine are due to their specific inhibition of vertebrate cellular responses to the Hedgehog (Hh) family of secreted growth factors, as first suggested by similarities between the Vertarum-induced developmental malformations and holoprosencephaly-like abnormalities associated with loss of Sonic hedgehog (Shh) function. In accordance with this general mechanism, cyclopamine also has shown some promise in the treatment of medulloblastoma tumors caused by inappropriate Hh pathway activation. How cyclopamine specifically inhibits Hh pathway activation is unclear, but it appears to interfere with the initial events of vertebrate Hh signal reception, which involve the multi-pass transmembrane (TM) proteins Patched (Ptch) and Smoothened (Smo). During normal Hh signaling, Hh proteins bind to Ptch, thereby alleviating Ptch-mediated suppression of Smo, a distant relative of G protein coupled receptors (GCPRs). Smo activation then triggers a series of intracellular events, culminating in the activation of Gli-dependent transcription.

Cyclopamine appears to interfere with these signaling events by influencing Smo function, as it antagonizes Hh pathway activity in a Ptch-independent manner and exhibits attenuated potency toward an oncogenic, constitutively active form of Smo (W539L; SmoA1). While these observations suggest that cyclopamine may regulate Smo activity, they neither reveal the biochemical mechanism of Smo activation nor the molecular basis of cyclopamine action. Studies in Drosophila have shown that Hh stimulation is associated with changes in Smo phosphorylation state, subcellular localization, and perhaps protein conformation. In principle, cyclopamine-mediated inhibition of vertebrate Smo activity could perturb any of these cellular events.

Accordingly, the need exists to identify specific small molecule-protein binding partners, which enables the identification of novel chemical ligands for cellular proteins on a genomic scale.

### SUMMARY OF THE INVENTION

The present invention is based, in part, on methods for the identification of specific small molecule-protein binding partners for subsequent identification of chemical ligands for cellular proteins on a genomic scale. Thus, the present invention relates to a method of identifying an agent that binds to a pharmacologically relevant protein. The method includes contacting a cell containing one or more pharmacologically relevant nucleic acid molecules, such as cDNA molecules, with a library of labeled agents and detecting binding of one or more agents to the cell. The cell may be a eukaryotic cell, such as a Cos-1 cell, which can express one or more proteins encoded by the one or more pharmacologically relevant nucleic acid molecules. The cell may be in culture medium or bound to a solid support for example. In one embodiment, the cDNA molecules encode human, parasite, bacterial or viral proteins. In another embodiment, the agent is a small molecule.

As such, the methods are conveniently adaptable to a high throughput format, wherein a plurality (i.e., 2 or more) of cells, which can be the same or different, are examined in parallel. A high throughput format provides numerous advantages, including that test agents can be tested on several cells or on cells from a subject, thus allowing, for example, for the identification of a particularly effective concentration of an agent to be subsequently administered to the subject. Thus, a high throughput format allows for the examination of two, three, four, or more, different test agents, alone or in combination, on one or more cells, each containing one or more pharmacologically relevant nucleic acid molecules. Further, a high throughput format allows, for example, control samples (positive controls and or negative controls) to be run in parallel with test agents, including, for example, agents known to effectively treat specific disorders, such as cancers. Variations of the exemplified methods also are contemplated.

In order to express the one or more proteins, the cell may be transfected with an expression vector containing the nucleic acid molecules. In one embodiment, the members of a chemical library are labeled with a fluorescent tag and the detecting is performed using fluorescence activated cell sorting.

The methods of the present invention further include identifying the protein that binds to an agent from the library of labeled agents. One example for identifying the protein includes pooling the cDNAs into multiple orthogonal pools. Screening of the pools would thus generate a fixed number of hits, which would reveal the respective coordinate and the identity of the cDNA in question. Further expression of the identified cDNA may be accomplished by transfection of a eukaryotic cell with an expression vector containing the identified cDNA.

The present invention also provides methods of identifying a Hedgehog (Hh) pathway inhibitor. The method includes contacting a cell containing one or more nucleic acid molecules encoding a Hh pathway protein with a library of labeled agents and detecting binding of one or more agents to the cell, thereby identifying an agent that binds to a Hh pathway protein. In one embodiment, the cell is a eukaryotic cell, such as a Cos-1 cell. The cell may be in culture medium or bound to a solid support for example. In one embodiment, the members of a chemical library are labeled with a fluorescent tag and the detecting is performed using fluorescence activated cell sorting. In another embodiment, the agent is a small molecule. The methods for identifying a Hh pathway inhibitor may further include contacting the identified agent with a sample of cells from a subject, where the sample of cells has elevated Hh pathway activity, as compared to Hh pathway activity in corresponding normal cells. Detection of a decrease in Hh pathway activity in the sample of cells following contact identifies the agent as a Hh pathway inhibitor.

The present method can be practiced using test agents that are known to be effective in treating specific tumors having abnormally elevated Hh pathway activity in order to identify one or more agents that are particularly useful for treating the tumor being examined, or using test agents that are being examined for effectiveness. As such, in one aspect, the test agent examined according to the present method can be any type of compound, including, for example, a peptide, a polynucleotide, a peptidomimetic, or a small organic molecule, and can be one of a plurality of similar but different agents (e.g., a combinatorial library of test agents, which can be a randomized or biased library or can be a variegated library based on known effective agent such as the known Hh pathway antagonist, cyclopamine). In another aspect, the test agent comprises a known Hh pathway antagonist such as an antibody (e.g., an anti-SHH antibody and/or anti-IHH antibody) or a steroidal alkaloid or a derivative thereof (e.g., cyclopamine, jervine, or triparanol).

### BRIEF DESCRIPTION OF THE DRAWINGS

FIGS. 1A to 1E are pictorial diagrams showing that a photoaffinity derivative of cyclopamine cross-links with Smo.

FIGS. 2A to 2D are pictorial and graphical diagrams showing the binding of a fluorescently-labeled cyclopamine derivative to Smo-expressing cells.

FIGS. 3A and 3B are graphical diagrams showing that cyclopamine binds to the heptahelical bundle in Smo.

FIGS. 4A and 4B are pictorial diagrams showing that KAAD-cyclopamine binds to SmoA1 and promotes its exit from the ER.

FIGS. 5A and 5B are pictorial diagrams showing that Ptch activity promotes cyclopamine/Smo complexation.

### DETAILED DESCRIPTION OF THE INVENTION

The present invention is based on methods for the identification of specific small molecule-protein binding partners for subsequent identification of novel chemical ligands for cellular proteins on a genomic scale. As such, the methods of the invention provide for screening of small molecules against cells simultaneously expressing pharmacologically relevant targets. This allows a 100 to 10,000-fold increase in speed of screening with the associated decrease in cost, as compared to the design of assays for screening of individual targets.

In other words, because single cells expressing high levels of protein are detected, the methods of the invention allow for extremely high throughput screening of chemicals against a large number of pharmacologically relevant targets. For example, if 2000 cDNAs and 10,000 different chemicals are used, standard high throughput screening approaches would require 20 million individual binding assays. The methods of the invention permit the same amount of screening to be performed with just 10,000 FACS-based assays, which could be performed by a skilled operator in few weeks. The standard microplate-based approaches for screening throughput of this magnitude would be prohibitively expensive and time-consuming, requiring several months of operation using a high throughput liquid handling robot, a truckload (˜200,000) of 96-well plates, and about a metric ton of cell culture medium.

The binding affinity and specificity of small molecules for thousands of cellular proteins can thus be simultaneously evaluated, significantly accelerating the discovery of possible pharmaceutical agents. The use of fluorescence-activated cell sorting and the eukaryotic expression of cDNA libraries to identify cellular receptors for orphan protein ligands is well established. The methods of the invention extend this technology to the discovery of specific small molecule-protein binding partners, with a throughput that is currently unavailable.

Accordingly, in one embodiment of the invention, a large number of potentially pharmacologically relevant cDNAs for human, parasite, bacterial or viral proteins are assembled and cloned to expression vectors for high level expression in eukaryotic cells (such as Cos-1 cells). The cells are made to express individual or multiple proteins by standard methods known in the art (i.e. transfection with cDNA-expression vectors individually or in pools). The cells can be pooled in suspension, or arrayed on a solid support prior to or after transfection.

The chemical library is then labeled with a detectable label or tag. A detectable label is a group that is detectable at low concentrations, usually less than micromolar, preferably less than nanomolar, that can be readily distinguished from other analogous molecules, due to differences in molecular weight, redox potential, electromagnetic properties, binding properties, and the like. The detectable label may be a hapten, such as biotin, or a fluorescer, or an oligonucleotide, capable of non-covalent binding to a complementary receptor other than the active protein; a mass tag comprising a stable isotope; a radioisotope; a metal chelate or other group having a heteroatom not usually found in biological samples; a fluorescent or chemiluminescent group preferably having a quantum yield greater than 0.1; an electroactive group having a lower oxidation or reduction potential than groups commonly present in proteins; a catalyst such as a coenzyme, organometallic catalyst, photosensitizer, or electron transfer agent; or a group that affects catalytic activity such as an enzyme activator or inhibitor or a coenzyme.

Detectable labels may be detected directly by mass spectroscopy, detection of electromagnetic radiation, measurement of catalytic activity, potentiometric titration, cyclic voltametry, and the like. Alternatively labels may be detected by their ability to bind to a receptor thereby causing the conjugate to bind to the receptor. Binding of the conjugate to a receptor can be detected by any standard method such as ellipsometry, acoustic wave spectroscopy, surface plasmon resonance, evanescent wave spectroscopy, etc. when binding is to a surface, or by an immunoassay such as ELISA, FRET, SPA, RIA, in which the receptor may carry a label and an antibody to the active protein can be employed which may optionally carry a second label. Detectable labels may also be detected by use of separation methods such as HPLC, capillary or gel electrophoresis, chromatography, immunosorption, etc.

In one embodiment, the chemical library is fluorescently tagged and is then synthesized using combinatorial chemistry. Single or multiple chemicals from the tagged library are incubated with the pooled cells expressing approximately 1000 to 10,000 different cDNAs, or cells arrayed in solid support, and binding of the small molecules to cells is detected by fluorescence activated cell sorting (FACS) or imaging. A cell that binds to a given chemical would appear as a bright fluorescent cell.

If pooled cells are used, a hit is identified as a few bright cells in FACS, and the actual protein that bound to the chemical is then identified by subscreening. Subscreening could be performed, for example, by pooling 900 cDNAs in 60 orthogonal pools of 30 (each individual cDNA is in two pools, but all other cDNAs in these pools are different from each other). Screening of the 60 pools would generate two hits, which would reveal the coordinate and identity of the cDNA in question.

Compounds in the fluorescently tagged chemical library can contain essentially any organic core structure, including natural products, synthetic ligands, and the products of combinatorial synthesis. Multiple fluorophores and conjugation chemistries may be applicable. Other chemical tags can also utilized, including chromophores, binding epitopes, and radiolabels, permitting flow cytometric sorting by other detection strategies and the integration of this invention with non-flow cytometric screening approaches.

It has been previously shown that a wide range of tumors, including the majority of those originating from esophagus, stomach, biliary tract, and pancreas, displayed elevated levels of Hedgehog (Hh) pathway activity that were suppressed by the Hh pathway antagonist cyclopamine. Cyclopamine was also shown to suppress cell growth in vitro and cause regression of xenograft tumors in vivo.

As used herein, reference to the “Hh pathway” means the Hedgehog signal transduction pathway. The Hh pathway is well known (see, e.g., U.S. Pat. No. 6,277,566 B1; U.S. Pat. No. 6,432,970 B2; Lum and Beachy, Science 304:1755-1759, 2004; and Bale and Yu, Hum. Mol. Genet. 10:757-762, 2001, each of which is incorporated herein by reference). Briefly, SHH, IHH and DHH are a family of secreted proteins that act as ligand (Hh ligands) to initiate the Hh pathway, which is involved in morphogenetic development and proliferation of cells in a variety of tissues. Hh ligands bind to a receptor complex that includes Patched (PTCH; e.g., PTCH-1 in humans) and Smoothened (SMO), which a G-protein coupled receptor-like polypeptide. PTCH is an integral membrane protein with twelve transmembrane domains that acts as an inhibitor of SMO activation. Hh ligand binding to PTCH results in activation of SMO (see, e.g., Taipale et al., Nature 418:892-897, 2002, which is incorporated herein by reference), resulting in transduction of the signal and activation of the GLI family of transcriptional activators (e.g., GLI-1 and GLI-2, which act as transcriptional activators, and GLI-3, which acts as a transcriptional repressor), which are homologs of the Drosophila cubitis interruptis gene. Several kinases also are believed to be involved in the Hh pathway between SMO and the GLI transcription factors, including, for example, protein kinase A, which can inhibit GLI activity.

The Hedgehog (Hh) signaling pathway specifies patterns of cell growth and differentiation in a wide variety of embryonic tissues. Mutational activation of the Hh pathway, whether sporadic or in Gorlin Syndrome, is associated with tumorigenesis in a limited subset of these tissues, predominantly skin, cerebellum, and skeletal muscle (Wechsler-Reya and Scott, The developmental biology of brain tumors. Ann. Rev. Neurosci. 24, 385-428 (2001); and Bale and Yu, The hedgehog pathway and basal cell carcinomas. Hum. Mol. Genet. 10, 757-62. (2001)). Known pathway-activating mutations include those that impair the ability of PTCH (the target of Gorlin Syndrome mutations), a transporter-like Hh receptor (Taipale et al., Patched acts catalytically to suppress the activity of Smoothened. Nature 418, 892-7 (2002)), to restrain Smoothened (SMO) activation of transcriptional targets via the GLI family of latent transcription factors (see Wechsler-Reya and Scott, The developmental biology of brain tumors. Ann. Rev. Neurosci. 24, 385-428 (2001); Bale and Yu, The hedgehog pathway and basal cell carcinomas. Hum. Mol. Genet. 10, 757-62. (2001); Ingham and McMahon, Hedgehog signaling in animal development: paradigms and principles. Genes Dev 15, 3059-87 (2001) and Taipale and Beachy, The Hedgehog and Wnt signaling pathways in cancer. Nature 411, 349-54. (2001)). Binding of Hh ligand to PTCH is functionally equivalent to genetic loss of PTCH, in that pathway activation by either requires activity of SMO, a seven transmembrane protein that binds to and is inactivated by the pathway antagonist, cyclopamine (Chen et al., Inhibition of Hedgehog signaling by direct binding of cyclopamine to Smoothened. Genes Dev 16, 2743-8 (2002)).

The term “Hh pathway activity” is used herein to refer to the level of Hedgehog pathway signal transduction that is occurring in cells. Hh pathway activity can be determined using methods known in the art (see, e.g., Berman et al., Medulloblastoma growth inhibition by hedgehog pathway blockade. Science 297, 1559-61 (2002) and Chen et al., Small molecule modulation of Smoothened activity. Proc Natl Acad Sci USA99, 14071-6 (2002)). As used herein, the term “abnormally elevated,” when used in reference to Hh pathway activity, means that the Hh pathway activity is increased above the level typically found in normal (i.e., not cancer) differentiated cells of the same type as the cells from which the tumor are derived. As such, the term “abnormally elevated Hh pathway activity” refers to the level of Hh pathway activity in tumor cells as compared to corresponding normal cells. Generally, abnormally elevated Hh pathway activity is at least about 20% (e.g., 30%, 40%, 50%, 60%, 70%, or more) greater than the Hh pathway activity in corresponding normal cells. In this respect, it should be recognized that Hh pathway activity is determined with respect to a population of cells, which can be a population of tumor cells or a population of normal cells, and, therefore, is an average activity determined from the sampled population.

Reference herein to “corresponding normal cells” means cells that are from the same organ and of the same type as the tumor cell type. In one aspect, the corresponding normal cells comprise a sample of cells obtained from a healthy individual. Such corresponding normal cells can, but need not be, from an individual that is age-matched and/or of the same sex as individual providing the tumor cells being examined. In another aspect, the corresponding normal cells comprise a sample of cells obtained from an otherwise healthy portion of tissue of a subject having a similar tumor.

The term “cancer” as used herein, includes any malignant tumor including, but not limited to, carcinoma or sarcoma. Cancer arises from the uncontrolled and/or abnormal division of cells that then invade and destroy the surrounding tissues. As used herein, “metastasis” refers to the distant spread of a malignant tumor from its sight of origin. Cancer cells may metastasize through the bloodstream, through the lymphatic system, across body cavities, or any combination thereof. The term “benign” refers to a tumor that is noncancerous, e.g. its cells do not proliferate or invade surrounding tissues. The term “malignant” refers to a tumor that is metastastic or no longer under normal cellular growth control.

Cancers include, but are not limited to, the following organs or systems: cardiac, lung, gastrointestinal, genitourinary tract, liver, bone, nervous system, gynecological, hematologic, skin, and adrenal glands. Thus, the methods herein can be used for identifying small molecules useful in treating gliomas (Schwannoma, glioblastoma, astrocytoma), neuroblastoma, pheochromocytoma, paraganlioma, meningioma, adrenalcortical carcinoma, medulloblastoma, rhabdomyoscarcoma, kidney cancer, vascular cancer of various types, osteoblastic osteocarcinoma, prostate cancer, ovarian cancer, uterine leiomyomas, salivary gland cancer, choroid plexus carcinoma, mammary cancer, pancreatic cancer, colon cancer, and megakaryoblastic leukemia. Skin cancer includes malignant melanoma, basal cell carcinoma, squamous cell carcinoma, Karposi's sarcoma, moles dysplastic nevi, lipoma, angioma, dermatofibroma, keloids, and psoriasis. In one embodiment, the cancer is metastatic melanoma.

As used herein, a “Hh pathway antagonist” can be any antagonist that interferes with Hh pathway activity, thereby decreasing the abnormally elevated Hh pathway in the tumor cells. As such, the Hh pathway antagonist can be a peptide, a polynucleotide, a peptidomimetic, a small organic molecule, or any other molecule. Hh pathway antagonists are exemplified by antibodies, including anti-SHH antibodies, anti-IHH antibodies, and/or anti-DHH antibodies, each of which can bind to one or more Hh ligands and decrease ligand stimulated Hh pathway activity. Hh pathway antagonists are further exemplified by SMO antagonists such as steroidal alkaloids and derivatives thereof, including, for example, cyclopamine and jervine (see, e.g., Chen et al., Genes Devel. 16:2743-2748, 2002; and U.S. Pat. No. 6,432,970 B2, each of which is incorporated herein by reference), and SANT-1, SANT-2, SANT-3, and SANT-4 (see Chen et al., Proc. Natl. Acad. Sci., USA 99:14071-14076, 2002, which is incorporated herein by reference); triparanol provides another example of an agent that can act as an Hh pathway antagonist (see, e.g., U.S. Pat. No. 6,432,970 B2). As exemplified herein, an anti-SHH antibody and cyclopamine effectively reduced abnormally elevated Hh pathway activity in a variety of tumor cells and reduced viability of the cells in vitro, and cyclopamine has been shown to suppress growth of pancreatic tumor xenografts in nude mice.

The term “antibody” is meant to include intact molecules of polyclonal or monoclonal antibodies, chimeric, single chain, and humanized antibodies, as well as fragments thereof, such as Fab and F(ab′)₂, Fv and SCA fragments which are capable of binding an epitopic determinant. Monoclonal antibodies are made from antigen containing fragments of the protein by methods well known to those skilled in the art (Kohler, et al., Nature, 256:495, 1975). An Fab fragment consists of a monovalent antigen-binding fragment of an antibody molecule, and can be produced by digestion of a whole antibody molecule with the enzyme papain, to yield a fragment consisting of an intact light chain and a portion of a heavy chain. An Fab′ fragment of an antibody molecule can be obtained by treating a whole antibody molecule with pepsin, followed by reduction, to yield a molecule consisting of an intact light chain and a portion of a heavy chain. Two Fab′ fragments are obtained per antibody molecule treated in this manner. An (Fab′)₂ fragment of an antibody can be obtained by treating a whole antibody molecule with the enzyme pepsin, without subsequent reduction. A (Fab′)₂ fragment is a dimer of two Fab′ fragments, held together by two disulfide bonds. An Fv fragment is defined as a genetically engineered fragment containing the variable region of a light chain and the variable region of a heavy chain expressed as two chains. A single chain antibody (“SCA”) is a genetically engineered single chain molecule containing the variable region of a light chain and the variable region of a heavy chain, linked by a suitable, flexible polypeptide linker.

As used herein, the terms “sample” and “biological sample” refer to any sample of cells suitable for the methods provided by the present invention. In one embodiment, the biological sample of the present invention is a tissue sample, e.g., a biopsy specimen such as samples from needle biopsy (i.e., biopsy sample). In other embodiments, the biological sample of the present invention is a sample of bodily fluid, e.g., serum, plasma, sputum, lung aspirate, urine, and ejaculate.

In one embodiment, the methods of the present invention may be screened for pharmacologically relevant compounds. As used herein, “pharmacologically relevant” refers to a compound that affects the functioning of a physiological process such as signal transduction by a cellular receptor, initiation, cessation or modulation of an immune response, modulation of heart function, nervous system function, or any other organ or organ system. Thus, an agent that binds to a pharmacologically relevant nucleic acid molecule is considered to be a pharmacologically relevant compound. A pharmacologically relevant compound may also stimulate or inhibit the activity of a bacteria, virus, fungus, or other infectious agent. A pharmacologically relevant compound may modulate the effects of a disease, that is prevent or decrease the severity of or cure a disease such as cancer, diabetes, atherosclerosis, high blood pressure, Parkinson's disease and other disease states. Screening for pharmacological activity may be performed as would be known in the art.

As used herein, the terms “reduce” and “inhibit” are used interchangeably because it is recognized that, in some cases, a decrease, for example, in Hh pathway activity can be reduced below the level of detection of a particular assay. As such, it may not always be clear whether the activity is “reduced” below a level of detection of an assay, or is completely “inhibited.” Nevertheless, it will be clearly determinable, following a treatment with a small molecule identified by the methods of the present invention, that the level of Hh pathway activity (and/or cell proliferation) is at least reduced from the level before treatment. Generally, contact of tumor cells having abnormally elevated Hh pathway activity with an Hh pathway antagonist reduces the Hh pathway activity by at least about 20% (e.g., 30%, 40%, 50%, 60%, 70%, or more).

Thus, in one aspect, the present invention provides a method of identifying small molecules that ameliorate a tumor comprising cells characterized by abnormally elevated Hh pathway activity in a subject. As used herein, the term “ameliorate” means that the clinical signs and/or the symptoms associated with the digestive tract tumor are lessened. The signs or symptoms to be monitored will be characteristic of a particular tumor and will be well known to skilled clinician, as will the methods for monitoring the signs and conditions. For example, the skilled clinician will know that the size or rate of growth of a tumor can monitored using a diagnostic imaging method typically used for the particular tumor (e.g., using ultrasound or magnetic resonance image (MRI) to monitor a pancreatic tumor).

As used herein, the term “test agent” means any compound that is being examined for a specific protein binding partner. The test agents examined according to the present methods can be any type of compound, including, for example, a peptide, a polynucleotide, a peptidomimetic, peptoids such as vinylogous peptoids, or a small organic molecule, and can be one or a plurality of similar but different agents such as a combinatorial library of test agents, which can be a randomized or biased library or can be a variegated library based on known effective agent such as the known Hh pathway antagonist, cyclopamine (see, for example, U.S. Pat. No. 5,264,563; and U.S. Pat. No. 5,571,698, each of which is incorporated herein by reference).

As used herein, a “combinatorial library” refers to a collection of compounds composed of one or more types of subunits. The sub-units may be selected from natural or unnatural moieties, including dienes, dienophiles, amino acids, nucleotides, sugars, lipids, and carbohydrates. The compounds of the combinatorial library differ in one or more ways with respect to the number, order, type or types of or modifications made to one or more of the subunits comprising the compounds. Alternatively, a combinatorial library may refer to a collection of “core molecules” which vary as to the number, type or position of R or functional groups they contain and/or identity of molecules composing the core molecule, for example, a diene and/or dienophile which react to form the core molecule.

Methods for preparing a combinatorial library of molecules, which can be tested for specific binding to cellular proteins on a genomic scale, are well known in the art and include, for example, methods of making a phage display library of peptides, which can be constrained peptides (see, for example, U.S. Pat. No. 5,622,699; U.S. Pat. No. 5,206,347; Scott and Smith, Science 249:386-390, 1992; Markland et al., Gene 109:13-19, 1991; each of which is incorporated herein by reference); a peptide library (U.S. Pat. No. 5,264,563, which is incorporated herein by reference); a peptidomimetic library (Blondelle et al., supra, 1995; a nucleic acid library (O'Connell et al., Proc. Natl. Acad. Sci., USA 93:5883-5887, 1996; Tuerk and Gold, Science 249:505-510, 1990; Gold et al., Ann. Rev. Biochem. 64:763-797, 1995; each of which is incorporated herein by reference; each of which is incorporated herein by reference); an oligosaccharide library (York et al., Carb. Res. 285:99-128, 1996; Liang et al., Science 274:1520-1522, 1996; Ding et al., Adv. Expt. Med. Biol. 376:261-269, 1995; each of which is incorporated herein by reference); a lipoprotein library (de Kruif et al., FEBS Lett. 399:232-236, 1996, which is incorporated herein by reference); a glycoprotein or glycolipid library (Karaoglu et al., J. Cell Biol. 130:567-577, 1995, which is incorporated herein by reference); or a chemical library containing, for example, drugs or other pharmaceutical agents (Gordon et al., J. Med. Chem. 37:1385-1401, 1994; Ecker and Crooke, supra, 1995; each of which is incorporated herein by reference).

Thus, in one embodiment, the methods of the invention are used to identify agents that bind to cellular proteins on a genomic scale. The method involves exposing at least one agent from a library of chemical agents to a cell expressing a protein comprising a functional portion of a cellular receptor for a time sufficient to allow binding of the agent to the functional portion of the cellular receptor; removing non-bound agents; and determining the presence of the agent bound to the functional portion of the cellular receptor, thereby identifying an agent to be tested for an ability to modulate a cellular receptor signal transduction pathway.

In one embodiment, the method includes the attachment of a combinatorial library molecule, or a portion thereof, to a solid matrix, such as agarose or plastic beads, microtiter wells, petri dishes, or membranes composed of, for example, nylon or nitrocellulose, and the subsequent incubation of the attached combinatorial library molecule in the presence of a potential combinatorial library molecule-binding compound or compounds. Attachment to the solid support may be direct or by means of a combinatorial-library-compound-specific antibody bound directly to the solid support. After incubation, unbound compounds are washed away, and component-bound compounds are recovered. By utilizing this procedure, large numbers of types of molecules may be simultaneously screened for receptor-binding activity.

In another embodiment, the methods are practiced in a high throughput format, thus allowing the examination of a plurality (i.e., 2, 3, 4, or more) of cell samples and/or test agents, which independently can be the same or different, in parallel. A high throughput format provides numerous advantages, including that test agents can be tested on several samples of cells from a single patient, thus allowing, for example, for the identification of a particularly effective concentration of an agent to be administered to the subject, or for the identification of a particularly effective agent to be administered to the subject. As such, a high throughput format allows for the examination of two, three, four, or more, different test agents, alone or in combination, on cells expressing one or more cellular receptors for orphan protein ligands. Further, a high throughput format allows, for example, control samples (positive controls and or negative controls) to be run in parallel with test samples, including, for example, samples of cells known to be effectively treated with an agent being tested.

As such, a high throughput method of the invention can be practiced in any of a variety of ways. For example, different samples of cells obtained from different subjects can be examined, in parallel, with same or different amounts of one or a plurality of test agent(s); or two or more samples of cells obtained from one subject can be examined with same or different amounts of one or a plurality of test agent. In addition, cell samples, which can be of the same or different subjects, can be examined using combinations of test agents and/or known effective agents. Variations of these exemplified formats also can be used to identifying an agent or combination of agents useful for treating a tumor having abnormally elevated Hh pathway activity.

The high throughput (or ultra-high throughput) methods of the invention can be performed on a solid support (e.g., a microtiter plate, a silicon wafer, or a glass slide), wherein samples to be contacted with a test agent are positioned such that each is delineated from each other (e.g., in wells). Any number of samples (e.g., 96, 1024, 10,000, 100,000, or more) can be examined in parallel using such a method, depending on the particular support used. Where samples are positioned in an array (i.e., a defined pattern), each sample in the array can be defined by its position (e.g., using an x-y axis), thus providing an “address” for each sample. An advantage of using an addressable array format is that the method can be automated, in whole or in part, such that cell samples, reagents, test agents, and the like, can be dispensed to (or removed from) specified positions at desired times, and samples (or aliquots) can be monitored, for example, for Hh pathway activity and/or cell viability.

Abnormally elevated Hh pathway activity can be determined by measuring abnormally elevated expression of one or more (e.g., 1, 2, 3, or more) Hh pathway polypeptide(s), including, for example, one or more Hh ligands (e.g., SHH, IHH, and/or desert hedgehog), Hh ligand receptors (e.g., PTCH), or transcription factors (a GLI family member), or a combination of such Hh pathway polypeptides. The abnormally elevated expression can be detected by measuring the level of a polynucleotide encoding the Hh pathway polypeptide (e.g., RNA) using, for example, a hybridization assay, a primer extension assay, or a polymerase chain reaction (PCR) assay (e.g., a reverse transcription-PCR assay); or by measuring the level the Hh pathway polypeptide(s) using, for example, an immunoassay or receptor binding assay. Alternatively, or in addition, abnormally elevated activity of one or more (e.g., 1, 2, 3, or more) Hh pathway polypeptide(s) can be determined. For example, abnormally elevated activity of Hh pathway transcription factor (e.g., a GLI family member) can be detected by measuring increased binding activity of the transcription factor to a cognate transcription factor regulatory element (e.g., using an electrophoretic mobility shift assay), or by measuring increased expression of a reporter gene comprising a cognate transcription factor regulatory element. Expression of an Hh pathway polypeptide having an inactivating mutation can be identified using, for example, an antibody that specifically binds to the mutant, but not to the normal (wild type), Hh polypeptide, wherein the mutation is associated with abnormally elevated Hh pathway activity. For example, common mutations that result in expression of an inactivated PTCH can define unique epitopes that can be targeted by diagnostic antibodies that specifically bind the mutant, but not wild type, PTCH protein.

Certain agents identified in the methods of the invention can be further evaluated, detected, cloned, sequenced, and the like, either in solution or after binding to a solid support, by any method usually applied to the detection of a specific DNA sequence such as PCR, oligomer restriction (Saiki, et al., Bio/Technology, 3:1008-1012, 1985), allele-specific oligonucleotide (ASO) probe analysis (Conner, et al., Proc. Natl. Acad. Sci. USA, 80:278, 1983), oligonucleotide ligation assays (OLAs) (Landegren, et al., Science, 241:1077, 1988), and the like. Molecular techniques for DNA analysis have been reviewed (Landegren, et al., Science, 242:229-237, 1988).

Candidate agents are obtained from a wide variety of sources including libraries of synthetic or natural compounds. For example, numerous means are available for random and directed synthesis of a wide variety of organic compounds and biomolecules, including expression of randomized oligonucleotides and oligopeptides. Alternatively, libraries of natural compounds in the form of bacterial, fungal, plant and animal extracts are available or readily produced. Additionally, natural or synthetically produced libraries and compounds are readily modified through conventional chemical, physical and biochemical means, and may be used to produce combinatorial libraries. Known pharmacological agents may be subjected to directed or random chemical modifications, such as acylation, alkylation, esterification, amidification, etc., to produce structural analogs. Candidate agents are also found among biomolecules including, but not limited to: peptides, saccharides, fatty acids, steroids, purines, pyrimidines, derivatives, structural analogs or combinations thereof.

As such, the examples provided herein demonstrate that cyclopamine inhibits Hh pathway activation by binding directly to Smo. This binding interaction is localized to the heptahelical bundle and likely influences the Smo protein conformation. Cyclopamine binding is also sensitive to Ptch function, providing biochemical evidence for the action of Ptch on Smo structure. Collectively, these results provide a molecular basis for cyclopamine action, and suggest that the regulation of Smo activity by Ptch may involve endogenous small molecules. The invention is also useful for rapidly generating and developing large numbers of drug candidate molecules.

The following examples are provided to further illustrate the advantages and features of the present invention, but are not intended to limit the scope of the invention. While they are typical of those that might be used, other procedures, methodologies, or techniques known to those skilled in the art may alternatively be used.

### EXAMPLE 1

### Inhibition of Hedgehog Signaling by Direct Binding of Cyclopamine to Smoothened

This example demonstrates that cyclopamine inhibits Hh pathway activation by binding directly to Smo. The steroidal alkaloid, cyclopamine, has both teratogenic and anti-tumor activities due to its ability to specifically block cellular responses to vertebrate Hedgehog signaling. The data provided herein shows that this inhibitory effect is mediated by direct binding of cyclopamine to the heptahelical bundle of Smoothened (Smo). Cyclopamine also can reverse the retention of partially misfolded Smo in the endoplasmic reticulum, presumably through binding-mediated effects on protein conformation. These observations reveal the mechanism of cyclopamine's teratogenic and anti-tumor activities, and further suggest a role for small molecules in the physiological regulation of Smo.

Preparation of Synthetic Compounds and Cell-Based Assays: Procedures for the chemical synthesis of KAAD-cyclopamine, PA-cyclopamine, and BODIPY-cyclopamine will be described elsewhere (J. K. Chen and P. A. Beachy, manuscript in preparation). Assays for Hh pathway activation in Shh-LIGHT2 cells, a clonal NTH-3T3 cell line stably incorporating Gli-dependent firefly luciferase and constitutive Renilla luciferase reporters, were conducted as previously described (Taipale, J., et al. 2000. Effects of oncogenic mutations in Smoothened and Patched can be reversed by cyclopamine. Nature 406: 1005-9).

Preparation of Smo fusion proteins and deletion mutants: Both Smo-Myc₃ and SmoA1-Myc₃ are C-terminally fused to three consecutive Myc epitopes. The deletion mutant SmoΔCRD lacks amino acids 68 to 182, and SmoΔCT lacks amino acids 556 to 793. Smo-GFP is comprised of green fluorescent protein fused to the C-terminus of Smo, and the fluorescent proteins in SmoA1-YFP, and SmoA1-GFP are similarly fused to the C-terminus of SmoA1. All constructs were generated by PCR and verified by DNA sequencing.

Photoaffinity labeling of Smo proteins: Cos-1 cells were cultured in 6-well plates and transfected with Smo-Myc₃ or SmoA1-Myc₃ expression vectors (1 μg/well). Two days after transfection, each well was incubated with 1 μCi of ¹²⁵I-labeled PA-cyclopamine (˜0.5 nM final concentration) in phenol red-free DMEM containing 0.5% bovine calf serum and various concentrations of the indicated compounds for 10 minutes at 37° C. Solvent vehicle alone (MeOH or DMSO) was used as a control in these experiments. PA-cyclopamine was then activated by 254 nm light (80,000 μJ/cm²; Stratalinker UV-cross-linker) at room temperature. The cells were immediately chilled on ice, removed from the plates by scraping, and then directly lysed and sonicated in SDS-PAGE loading buffer. Total cell lysates were separated by SDS-PAGE and transferred to nitrocellulose for analysis by autoradiography and western blotting with an anti-Myc monoclonal antibody (9E10; Santa Cruz Biotechnology).

Endo H digestion of Smo proteins: Cos-1 cells were cultured in DMEM containing 10% fetal bovine serum in 6-well plates and transfected with Smo-Myc₃ or SmoA1-Myc₃ expression vectors (1 μg/well). One day after transfection, 5 μM KAAD-cyclopamine (in MeOH, final concentration 0.1%) was added to a well of the SmoA1-Myc₃-expressing cells. Two days after transfection, each well of cells washed twice with PBS and lysed with 300 μL of RIPA buffer (50 mM Tris-Cl, pH 7.5, 150 mM NaCl, 1% NP-40, 0.5% sodium deoxycholate, 1 mM EDTA, 1 (μg/ml leupeptin, 1 μg/ml aprotinin, 0.2 mM phenylmethylsulfonyl fluoride). Cell lysates were centrifuged at 20,000×g for 15 minutes at 4° C., and the supernatant was then centrifuged at 100,000×g for 30 minutes. The supernatant of the second centrifugation was then used for glycosidase treatments and/or SDS-PAGE. For glycosidase treatments, 45 μL of cell lysate was denatured in 0.5% SDS, 1% β-mercaptoethanol for 10 minutes at room temperature and then incubated in 50 mM sodium citrate (pH 5.5) and 50 units of endoglycosidase-H (New England Biolabs) at 37° C. overnight. The anti-Myc monoclonal antibody was used for western blotting, following SDS-PAGE separation and protein transfer to nitrocellulose.

Localization studies of Smo and SmoA1 proteins: C3H/10T1/2 cells (ATCC) were cultured in DMEM containing 10% fetal bovine serum, 0.5 μg/ml ZnSO₄ and β-mercaptoethanol (3.5 μL/500 ml DMEM) on glass coverslips (Bioptechs) in 6 cm² dishes. C3H/10T1/2 cells were transfected with either Smo-GFP, SmoA1-GFP, or SmoA1-YFP expression constructs, all of which yield functionally active proteins. To assess SmoA1 subcellular localization, either an ER marker (pECFP-ER; Clontech) or a Golgi marker (pECFP-Golgi; Clontech) was cotransfected with the SmoA1-YFP construct. One day after transfection, SmoA1-GFP expressing cells were treated with either 10 μM KAAD-cyclopamine or 1 μM SAG (in MeOH, final concentration 0.1%) for 16-20 hours. All cells were imaged on the second day after transfection, at 37° C. in a closed observation chamber (FCS2; Bioptechs) with constant laminar flow perfusion of culture medium with or without KAAD-cyclopamine or SAG. Fluorescent protein illumination, detection and imaging was performed on a Zeiss inverted microscope outfitted with a Xenon light source (Lambda DG4; Sutter instruments), single or dual-pass filters (Chroma Technologies), and a cooled CCD camera (Roper Scientific). Images were acquired and processed with Metamorph software (Universal Images).

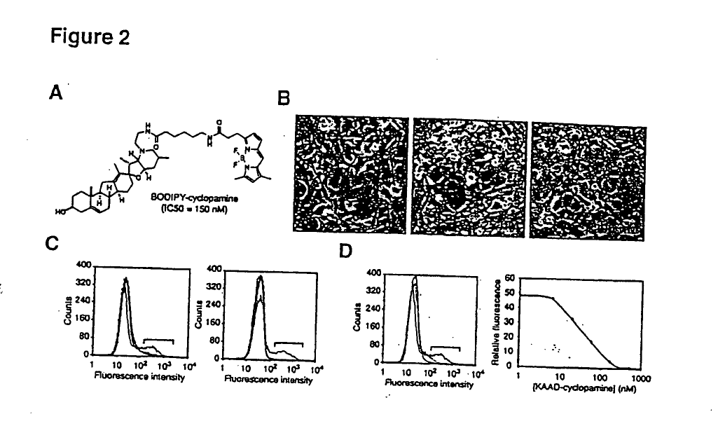

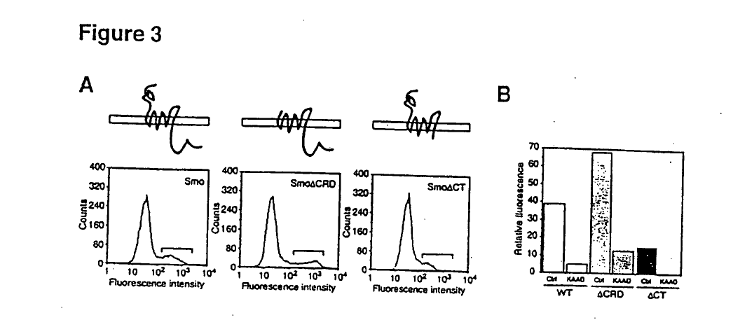

Fluorescence binding assay: Cos-1 cells were transfected in 6-well plates with the described expression vectors (1 μg/well), and after two days, incubated in DMEM containing 10% fetal bovine serum, 5 nM BODIPY-cyclopamine, and various concentrations of the indicated competitors for 4-6 h at 37° C. For flow cytometry experiments, the cells were then trypsinized, collected by centrifugation, resuspended in phenol red-free DMEM containing 0.5% bovine calf serum, and analyzed for green fluorescence (FACScan, Beckton Dickinson). A fluorescence intensity range that excludes non-transfected cells was then selected for quantification of specific BODIPY-cyclopamine binding (see brackets in FIGS. 2C, 2D, and 3A). Curve fitting analysis was performed with Kaleidograph (Synergy Software).

Studies of Ptch modulation of Smo photoaffinity labeling: Cos-1 cells were cultured in 6-well plates and transfected with Smo-Myc₃ (0.5 μg/well) and varying amounts of a mouse Ptch-Myc₃ expression construct (0, 1.2, 6, 30, and 150 ng/well). A GFP expression construct was also included in these transfections to normalize total DNA levels. One day after transfection, the Cos-1 cells were cross-linked with ¹²⁵I-labeled PA-cyclopamine and processed as described above. To evaluate the importance of Ptch activity in these assays, Cos-1 cells transfected with Smo-Myc₃ (0.5 μg/well) and either Ptch-Myc₃ or GFP expression constructs (0.1 μg/well) were also treated with either ShhN (the N-terminal domain of Shh without cholesterol modification) conditioned medium or control medium for 30 min at 37° C. prior to photoaffinity cross-linking.

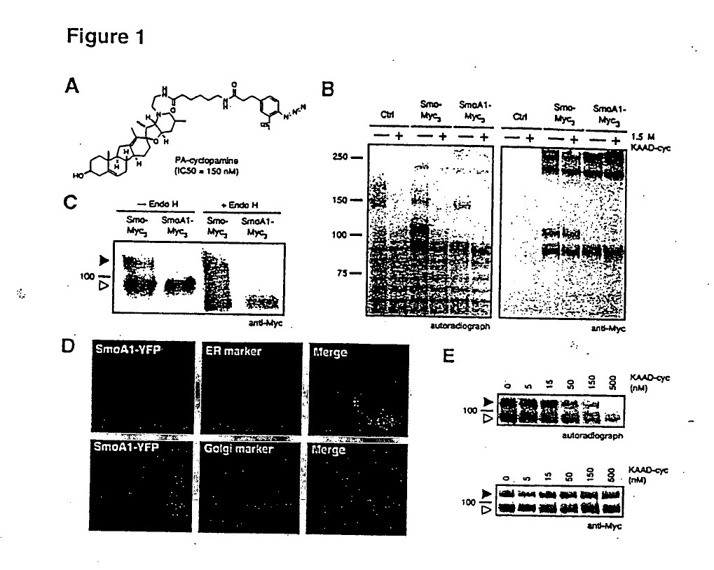

A photoaffinity derivative of cyclopamine specifically cross-links Smo: To determine whether cyclopamine acts directly on Smo, a photoaffinity reagent (PA-cyclopamine; FIG. 1A) was shown to inhibit Shh signaling in a mouse cultured cell assay (Shh-LIGHT2; Taipale, J., et al. 2000. Effects of oncogenic mutations in Smoothened and Patched can be reversed by cyclopamine. Nature 406: 1005-9) with an IC50 comparable to that of cyclopamine itself (150 nM versus 300 nM, respectively). Light activation of ¹²⁵I-labeled PA-cyclopamine in live NTH-3T3 cells did not detectably label endogenous mouse Smo (mSmo, henceforth referred to as Smo). As endogenous Smo in these cells is expressed at low levels (Taipale, et al. 2002. Patched acts catalytically to suppress the activity of Smoothened. Nature 418: 892-6), it was determined whether binding could be detected in Cos-1 cells transiently transfected with a construct for high-level expression of Smo C-terminally fused to Myc epitopes. Under these conditions, Smo is observed as two distinctly migrating forms, both of which were readily labeled by ¹²⁵I-labeled PA-cyclopamine upon photoactivation (FIG. 1B). Essentially no cross-linking to presumably non-native, SDS-resistant Smo aggregates was observed, reflecting the requirement for an intact cyclopamine-binding site. Consistent with the resistance of SmoA1 to cyclopamine, PA-cyclopamine also was unable to efficiently cross-link this oncogenic Smo mutant, which is observed as a single form (FIG. 1B). Thus, the W539L mutation either directly disrupts the cyclopamine-binding site or alters the balance between active and inactive Smo states.

To investigate the nature of the differently migrating forms of Smo and SmoA1, the two forms were characterized by digestion with endoglycosidase H (endo H), an enzyme capable of hydrolyzing the simpler glycosyl adducts characteristic of the endoplasmic reticulum (ER), but not the more complex adducts associated with post-ER compartments such as the Golgi or the plasma membrane. One form of Smo is endo H-sensitive and presumably localized to the ER; the second form is endo H-resistant and likely represents post-ER protein (FIG. 1C). All of SmoA1 protein is completely endo H-sensitive (FIG. 1C), suggesting that SmoA1 is trapped in the ER. This localization is confirmed by co-localization of a constitutively active, fluorescent protein-tagged form of SmoA1 (SmoA1-YFP) with an ER-specific marker (FIG. 1D). Accordingly, SmoA1-YFP does not co-localize with a Golgi-specific marker (FIG. 1D).

The specificity of PA-cyclopamine cross-linking of Smo is indicated by its efficient competition by a strongly inhibitory dose of KAAD-cyclopamine, a potent derivative of cyclopamine (IC50=20 nM in the Shh-LIGHT2 assay; Taipale, J., et al. 2000. Effects of oncogenic mutations in Smoothened and Patched can be reversed by cyclopamine. Nature 406: 1005-9) (FIG. 1B). Upon titration of this reaction with increasing doses of KAAD-cyclopamine, it was observed that Smo labeling was competed at a concentration range (FIG. 1E) comparable to that required for inhibition of Shh signaling. The cross-linking competition assay thus appears to faithfully reflect the in vivo properties of cyclopamine derivatives in pathway inhibition.

As described above, FIG. 1 shows that a photoaffinity derivative of cyclopamine cross-links Smo. FIG. 1A shows the chemical structure of the photoaffinity derivative PA-cyclopamine and its inhibitory activity on Shh signaling. FIG. 1B shows that upon photoactivation, ¹²⁵I-labeled PA-cyclopamine cross-links two forms of Smo fused at its C-terminus to Myc epitopes (Smo-MyC₃) in Cos-1 cells, and this labeling is inhibited by 1.5 μM KAAD-cyclopamine (left panel). Non-transfected cells and SmoA1-Myc₃-expressing cells do not yield specifically cross-linked products. Western analysis with an anti-Myc antibody demonstrates that Smo-Myc, and SmoA1-Myc₃ expression levels are comparable and are not affected by KAAD-cyclopamine treatment (right panel). FIG. 1C shows that the two Smo-Myc₃ forms represent different glycosylation states, as one is endo H-sensitive (open arrowhead) and the other, endo H-resistant (solid arrowhead). SmoA1-Myc₃ is exclusively observed as an endo H-sensitive form. Phosphatase treatment did not alter the mobilities of Smo-Myc₃ or SmoA1-MyC₃ proteins. FIG. 1D shows that endo-H sensitivity is indicative of ER-localization, as confirmed by the co-localization of SmoA1-YFP (pseudocolored green, top left panel) and an ER marker (pseudocolored red, top middle panel; merge, top right panel) in C3H/10T1/2 cells. Cells expressing both SmoA1-YFP (pseudocolored green, bottom left panel) and a Golgi marker (pseudocolored red, bottom middle panel) exhibit no co-localization (merge, bottom right panel). FIG. 1E shows that KAAD-cyclopamine abrogates Smo-MyC₃/PA-cyclopamine cross-linking in a manner that is consistent with its inhibitory activity in the Shh-LIGHT2 assay (left panel) without altering cellular levels of Smo-Myc₃ (right panel). Both ER- and post-ER forms of Smo-Myc₃ are depicted as described above. Cross-linking of PA-cyclopamine to an endogenous 160 kD protein (panel B) was competed by KAAD-cyclopamine only at concentrations significantly higher than those required for pathway inhibition.

A fluorescent derivative of cyclopamine specifically binds Smo-expressing cells: The specificity of cyclopamine binding to Smo was further confirmed by assays using BODIPY-cyclopamine (FIG. 2A); a fluorescent derivative that retains potency in Shh signaling inhibition (IC50=150 nM). This derivative bound with high capacity to a subpopulation of Cos-1 cells transiently transfected for expression of Smo, as determined by fluorescence microscopy and flow cytometry (FIGS. 2B and 2C), but did not bind cells expressing SmoA1, nor to cells expressing the Smo protein from Drosophila (FIG. 2C), where cyclopamine has no effect on Hh signaling (Taipale, J., et al. 2000. Effects of oncogenic mutations in Smoothened and Patched can be reversed by cyclopamine. Nature 406: 1005-9). BODIPY-cyclopamine also did not bind cells expressing mouse Frizzled7 protein, the closest structural relative of Smo and a member of the Frizzled family of Wnt receptors, nor to cells expressing mouse Ptch (FIG. 2C). BODIPY-cyclopamine binding to cells expressing Smo was blocked by KAAD-cyclopamine in a dose-dependent manner (FIGS. 2B and 2D), with an apparent dissociation constant for KAAD-cyclopamine (K_{d}=23 nM) comparable to its biological potency. Similar results were obtained with paraformaldehyde-fixed cells, ruling out possible artifacts caused by indirect effects of endocytosis or other trafficking processes in Smo-expressing cells. It was thus observed in both the covalent PA-cyclopamine cross-linking assay and in the non-covalent BODIPY-cyclopamine binding assay that cyclopamine interacts specifically with Smo and does so with an affinity that corresponds to its IC50 for pathway inhibition. These results strongly argue for a direct mechanism of cyclopamine action on Smo.

As described above, FIG. 2 shows that a fluorescent derivative of cyclopamine binds Smo-expressing cells. FIG. 2A provides the chemical structure of the fluorescent compound BODIPY-cyclopamine and its inhibitory activity on Shh signaling. FIG. 2B shows that BODIPY-cyclopamine binds to a subpopulation of Cos-1 cells transfected with a Smo expression construct, and KAAD-cyclopamine inhibits this interaction (KAAD-cyclopamine concentrations are shown in boldface type). FIG. 1C shows that specific BODIPY-cyclopamine binding to Smo-expressing Cos-1 cells can also be detected by flow cytometry (black trace; left and right panels), as this subpopulation exhibits high fluorescence intensity (brackets). In contrast, cells expressing SmoA1 (blue trace; left panel), mouse Ptch (green trace; left panel), mouse Frizzled 7 (red trace; right panel), or Drosophila Smo (blue trace; right panel) fail to bind BODIPY-cyclopamine in a specific manner. FIG. 1D shows that flow cytometry quantitation of specific BODIPY-cyclopamine binding to Smo-expressing cells (bracket; left panel) can also be used to determine the affinities of Smo ligands through competitive binding assays (black trace=0 nM; orange trace=80 nM; and red trace=3 μM KAAD-cyclopamine; left panel), yielding an apparent dissociation constant of 23 nM for the KAAD-cyclopamine/Smo complex (right panel).

Cyclopamine binding is localized to the Smo heptahelical bundle: Having established Smo as the direct cellular target of cyclopamine, the structural determinants of Smo required for its binding were then investigated. It was found that BODIPY-cyclopamine can bind cells expressing Smo proteins that lack either the N-terminal, extracellular cysteine-rich domain (SmoΔCRD) or the cytoplasmic C-terminal domain (SmoΔCT) (FIG. 3A), and that binding to either protein is sensitive to competition by KAAD-cyclopamine (FIG. 3B). The different levels of BODIPY-cyclopamine binding associated with Smo, SmoΔCRD, and SmoΔCT likely reflect variations in protein expression levels rather than differences in protein-ligand affinities, as KAAD-cyclopamine inhibited the BODIPY-cyclopamine binding to these different proteins with similar potencies. Thus, despite the importance of the cytoplasmic C-terminal domain of Smo for Hh signaling, and of the homologous CRD of Frizzled receptors for Wnt-binding and receptor activation (Bhanot, P., et al. 1996. A new member of the frizzled family from Drosophila functions as a Wingless receptor. Nature 382: 225-30), cyclopamine binding of Smo appears not to require these domains. Instead, the cyclopamine binding site in Smo is localized to the heptahelical domain of this integral membrane protein.

As described above, FIG. 3 shows that cyclopamine binds to the heptahelical bundle in Smo. In FIG. 3A Cos-1 cells expressing either SmoΔCRD (middle panel) or SmoΔCT (right panel) were treated with BODIPY-cyclopamine and analyzed by flow cytometry. As with Smo-expressing cells (left panel), a subpopulation of these cells exhibit specific BODIPY-cyclopamine binding (see brackets). FIG. 3B shows that BODIPY-binding to cells expressing these Smo proteins is inhibited by 150 nM KAAD-cyclopamine to similar extents, demonstrating that cyclopamine binds wildtype Smo, SmoΔCRD, and SmoΔCT with comparable affinities.

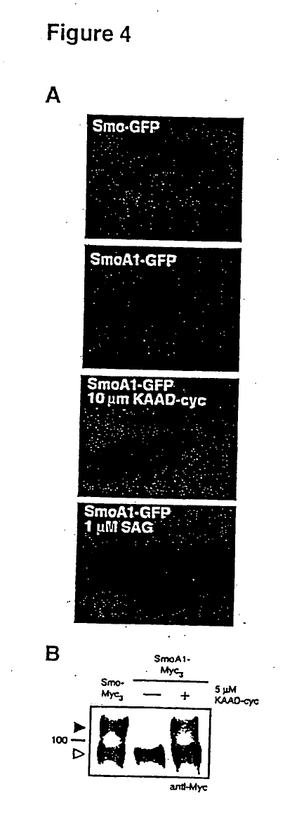

Cyclopamine binding can alter the conformation of SmoA1: The binding of cyclopamine to the Smo heptahelical bundle suggests that Smo inhibition by this natural product involves a protein conformational shift. The structurally related GPCR family employs a global conformational change to link the binding of extracellular ligands to the recruitment of intracellular components, in this case G proteins (Christopoulos, A. and Kenakin, T. 2002. G protein-coupled receptor allosterism and complexing. Pharmacol Rev. 54: 323-74). Although G proteins have not been implicated in Smo-mediated pathway activation, an effect of cyclopamine binding on Smo structure is supported by the ability of KAAD-cyclopamine to reverse ER-retention of SmoA1. It was observed that upon treatment with KAAD-cyclopamine, the localization of green fluorescent protein-tagged SmoA1 (SmoA1-GFP) in C3H/10T1/2 cells expanded to include cytoplasmic vesicles and the plasma membrane, thus more closely resembling the subcellular distribution of GFP-tagged wild-type Smo (Smo-GFP) (FIG. 4A). This change in localization is confirmed by a corresponding shift in SmoA1 glycosylation state, as evidenced by the partial conversion of SmoA1 to an endo H-resistant form (FIG. 4B). Similar changes in SmoA1 localization were observed with a Hh pathway agonist that also acts directly on Smo (FIG. 4A), ruling out activity state changes as a critical determinant of SmoA1 exit from the ER.

The ER retention of transmembrane proteins, including heptahelical receptors, has been associated with a quality control mechanism that monitors structurally disordered proteins. For example, the most common mutation in cystic fibrosis causes the CFTR channel to be sequestered in the ER (Cheng, et al. 1990. Defective intracellular transport and processing of CFTR is the molecular basis of most cystic fibrosis. Cell 63: 827-34), and the δ opioid receptor is thought to be extensively retained in the ER due to misfolding (Ellgaard, L., et al. 1999. Setting the standards: quality control in the secretory pathway. Science 286: 1882-8). In this latter case, protein export from the ER can be stimulated by the addition of membrane-permeable agonists and antagonists that bind and change receptor structure (Petaja-Repo, et al. 2002. Ligands act as pharmacological chaperones and increase the efficiency of delta opioid receptor maturation. EMBO J. 21: 1628-1637). The observations with SmoA1 and KAAD-cyclopamine therefore suggest that the W539L mutation produces a partially disordered Smo protein that is retained by the ER quality control system, and that the binding of small molecules such as cyclopamine or SAG alters SmoA1 structure to resemble a more native state, thus permitting export. In these experiments, higher concentrations of KAAD-cyclopamine than required for inhibition were used to ensure saturation of binding to SmoA1, which has a lower apparent affinity for cyclopamine and its derivatives.

As described above, FIG. 4 shows that KAAD-cyclopamine binds to SmoA1 and promotes its exit from the ER. FIG. 4A shows that Smo-GFP is localized in the plasma membrane and cytoplasmic vesicles of C3H/10T1/2 cells. The ER-localization of SmoA1-GFP in C3H/10T1/2 cells is reversed by 10 μM KAAD-cyclopamine or 1 μM SAG, a Hh pathway agonist that directly binds Smo. FIG. 4B shows the glycosylation states of SmoA1-Myc₃ upon treatment, with 5 μM KAAD-cyclopamine, which includes both endo H-sensitive (open arrowhead) and endo H-resistant (solid arrowhead) forms.

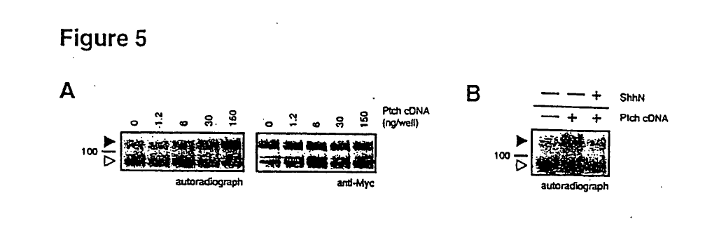

Ptch activity modulates cyclopamine binding to Smo: As both cyclopamine and Ptch negatively regulate Smo activity, it was then investigated how Ptch activity influences the ability of Smo to bind cyclopamine. It was found that increased levels of mouse Ptch expression in Cos-1 cells dramatically enhanced the photoaffinity cross-linking of post-ER Smo by ¹²⁵I-labeled PA-cyclopamine (FIG. 5A). In contrast, the labeling of ER-localized Smo was not affected, and cellular concentrations of either Smo form were not altered by Ptch expression. Treatment of the Smo- and Ptch-expressing cells with the N-terminal domain of Shh was able to reverse the effect of Ptch expression on PA-cyclopamine/Smo cross-linking, confirming its dependence on Ptch activity (FIG. 5B).

These results provide some insights into the regulation of Smo by Ptch. First, Ptch appears to act only on post-ER Smo, as the PA-cyclopamine cross-linking of ER-localized Smo is independent of Ptch expression levels. This subcellular compartmentalization of Ptch action is consistent with previous observations that Ptch is primarily localized to endosomal/lysosomal vesicles and the plasma membrane (Capdevila, J., et al. 1994. Subcellular localization of the segment polarity protein patched suggests an interaction with die wingless reception complex in Drosophila embryos. Development 120: 987-98; Fuse, et al. 1999. Sonic hedgehog protein signals not as a hydrolytic enzyme but as an apparent ligand for patched. Proc. Natl. Acad. Sci. U.S.A. 96: 10992-9; Denef, N., et al. 2000. Hedgehog induces opposite changes in turnover and subcellular localization of patched and smoothened. Cell 102: 521-31). Second, the ability of Ptch expression to significantly increase post-ER Smo labeling by PA-cyclopamine without influencing overall protein levels suggests that Ptch activity alters Smo conformation. It also appears that Ptch and cyclopamine promote inactive Smo states that may be structurally related.

As described above, FIG. 5 shows that Ptch activity promotes cyclopamine/Smo complexation. FIG. 5A shows that PA-cyclopamine crosslinking of post-ER Smo-Myc₃ (solid arrowhead) in Cos-1 cells is significantly increased upon Ptch expression in a dose-dependent manner (left panel). The labeling of ER-localized Smo-Myc₃ (open arrowhead; left panel) is not affected by Ptch expression and overall Smo-Myc, expression levels remain constant (right panel). FIG. 5B shows that ShhN reverses the effects of Ptch expression on PA-cyclopamine/Smo cross-linking.

Endogenous small molecules may regulate Smo activity: Exactly how Ptch influences Smo conformation remains enigmatic, despite extensive genetic analyses of the Hh pathway. Although it was initially proposed that Ptch and Smo form a heteromeric receptor (Stone, D. M., et al. 1996. The tumor-suppressor gene patched encodes a candidate receptor for Sonic hedgehog. Nature 384: 129-34), it is now believed that Smo activity is modulated by Ptch in an indirect, non-stoichiometric manner (Taipale, et al. 2002. Patched acts catalytically to suppress the activity of Smoothened. Nature 418: 892-6). In the case of the Frizzled family of seven-TM receptors, which are closely related to Smo in structure, receptor activation involves the binding of Wnt ligands to the Frizzled CRD (Bhanot, P., et al. 1996. A new member of the frizzled family from Drosophila functions as a Wingless receptor. Nature 382: 225-30) and recruitment of an LDL receptor-related protein (Pinson, et al. 2000. An LDL-receptor-related protein mediates Wnt signaling in mice. Nature 407: 535-8; Wehrli, M., et al. 2000. arrow encodes an LDL-receptor-related protein essential for Wingless signaling. Nature 407: 527-30). No analogous protein interactions have been associated with Smo activation, and removal of the Smo CRD does not appear to significantly alter Smo function or its suppression by Ptch (Taipale et al. 2002).

These observations coupled with the susceptibility of Smo to cyclopamine suggest that Smo regulation may involve endogenous small molecules rather than direct protein-protein interactions. Consistent with this model, Ptch is structurally related to the resistance-nodulation-cell division family of prokaryotic permeases (Tseng, T. X, et al. 1999. The RND permease superfamily: an ancient, ubiquitous and diverse family that includes human disease and development proteins. J. Mol. Microbiol. Biotechnol. 1: 107-25) and to the Niemann-Pick C1 protein, which is believed to regulate endosomal cholesterol levels through a proton-dependent transporter activity (Davies, J. R, et al. 2000. Transmembrane molecular pump activity of Niemann-Pick C1 protein. Science 290: 2295-8). Ptch action might similarly affect the subcellular and/or intramembrane distribution of hydrophobic molecules, thus influencing Smo activity by altering the localization of an endogenous Smo ligand. Alternatively, this Ptch activity could influence membrane structure and Smo trafficking (Sprong, P L, et al. 2001. How proteins move lipids and lipids move proteins. Nat. Rev. Mol. Cell. Biol. 2: 504-13); a shift in Smo localization might then be accompanied by activity-modulating changes in the molecular composition of specific subcellular compartments (Sprong et al. 2001).

Pharmacological modulation of Smo activity may be therapeutically useful: The demonstration of cyclopamine binding to Smo establishes the mechanism of action for this plant-derived teratogen. The data provided herein show that cyclopamine interacts with the Smo heptahelical bundle, thereby promoting a protein conformation that is structurally similar to that induced by Ptch activity. Equally important, these studies reveal the molecular basis for cyclopamine anti-tumor activity (Berman, D. M., et al. 2002. Medulloblastoma growth inhibition by Hedgehog pathway blockade. Science 297: 1559-61), and validate Smo as a therapeutic target in the treatment of Hh-related diseases. Aberrant Hh pathway activation has been associated with several cancers, such as medulloblastoma, rhabdomyoscarcoma, and basal cell carcinoma (Taipale, J. and Beachy, P. A. 2001. The Hedgehog and Wnt signaling pathways in cancer. Nature 411: 349-54; Wicking and McGlinn, 2001. The role of hedgehog signaling in tumorigenesis. Cancer Lett. 173: 1-7), and many of these tumors involve loss-of-function mutations in Ptch or activating mutations in Smo. As a specific Smo antagonist, cyclopamine may be generally useful in the treatment of such cancers, a therapeutic strategy further supported by the absence of observable toxicity in cyclopamine-treated animals (Keeler and Binns. 1965. Teratogenic compounds of Veratrum Californicum (Durand) I. Preparation and characterization of fractions and alkaloids for biologic testing. Can. J. Biochem. 44: 819-28; Berman et al. 2002). Additional Smo antagonists might also be discovered through small molecule screens for specific Hh pathway inhibitors, thus comprising a class of pharmacological agents with possible utility in the treatment of Hh-related oncogenesis.

Although the invention has been described with reference to the above example, it will be understood that modifications and variations are encompassed within the spirit and scope of the invention. Accordingly, the invention is limited only by the following claims.

What is claimed is:

1. A method of identifying an agent that binds to a protein comprising,
(a) contacting a cell containing one or more nucleic acid molecules encoding a pharmacologically relevant protein with a library of labeled agents; and
(b) detecting binding of one or more agents to the cell, thereby identifying an agent that binds to a pharmacologically relevant protein.

2. The method of claim 1, wherein the cell is a eukaryotic cell.

3. The method of claim 2, wherein the eukaryotic cell is a Cos-1 cell.

4. The method of claim 2, wherein the cell expresses one or more proteins encoded by the one or more pharmacologically relevant nucleic acid molecules.

5. The method of claim 4, wherein the cell is transfected with an expression vector containing the nucleic acid molecule.

6. The method of claim 1, wherein the library is labeled with a fluorescent tag, and the detecting is performed using fluorescence activated cell sorting.

7. The method of claim 1, wherein the one or more pharmacologically relevant nucleic acid molecules are cDNA molecules.

8. The method of claim 7, wherein the cDNA molecules encode eukaryotic or prokaryotic proteins.

9. The method of claim 8, wherein the cDNA molecules encode human, parasite, bacterial or viral proteins.

10. The method of claim 1, wherein the cell is bound to a solid support.

11. The method of claim 1, wherein the agent is a small molecule.

12. The method of claim 1, further comprising identifying the protein that bound the agent.

13. The method of claim 12, wherein identifying the protein comprises:
(a) pooling the nucleic acid molecules into orthogonal pools,
(b) detecting the nucleic acid molecule bound to the labeled agent, and
(c) expressing the nucleic acid molecule in a cell, thereby identifying the protein bound to the agent.

14. The method of claim 13, wherein each nucleic acid molecule is contained in two of the orthogonal pools.

15. A method of identifying a Hh pathway inhibitor comprising,
(a) contacting a cell containing one or more nucleic acid molecules encoding a Hh pathway protein with a library of labeled agents; and
(b) detecting binding of one or more agents to the cell, thereby identifying an agent that binds to a Hh pathway protein.

16. The method of claim 15, wherein the cell is a eukaryotic cell.

17. The method of claim 15, wherein the library is labeled with a fluorescent tag, and the detecting is performed using fluorescence activated cell sorting.

18. The method of claim 15, wherein the cell is bound to a solid support.

19. The method of claim 15, wherein the agent is a small molecule.

20. The method of claim 15, further comprising,
(c) contacting the identified agent with a sample of cells from a subject, wherein the sample of cells has elevated Hh pathway activity, as compared to Hh pathway activity in corresponding normal cells; and
(d) detecting a decrease in Hh pathway activity in the sample of cells following contact, thereby identifying the agent as a Hh pathway inhibitor.
